(19) United States
(12) Patent Application Publication
(10) Pub. No.: US 2010/0027731 A1
(43) Pub. Date: Feb. 4, 2010

(54) BWR START UP CORROSION PROTECTION

(75) Inventors: Christopher John Wood, Mountain View, CA (US); Susan Elaine Garcia, Paso Robles, CA (US)

Correspondence Address: TREGO, HINES & LADENHEIM, PLLC, 9300 HARRIS CORNERS PARKWAY, SUITE 210, CHARLOTTE, NC, 28269-3797, US

(73) Assignee: Electric Power Research Institute, Inc., Charlotte, NC (US)

(21) Appl. No.: 12/501,528

(22) Filed: Jul. 13, 2009

Related U.S. Application Data
(60) Provisional application No. 61/085,260, filed on Jul. 31, 2008.

(51) Int. Cl. G21C 9/00

(52) U.S. Cl. 376/306

(57) ABSTRACT

The oxidizing chemistry environment of BWR reactor water is a key factor promoting intergranular stress corrosion cracking of stainless steel and nickel based alloys used in reactor coolant system piping and vessel internals. This is typically mitigated during power operation with hydrogen injection. However, this method is only effective when the reactors are at power. Accordingly, this invention proposes a method of reducing electrochemical corrosion potential during the start-up phase of BWR reactors. The method includes the steps of providing a mitigation additive adapted to reduce electrochemical corrosion of a BWR reactor; and injecting the mitigation additive into the BWR reactor at a predetermined location prior to hydrogen injection coming online.

This application claims the benefit of Provisional Application No. 61/085,260 filed on Jul. 31, 2008.

### TECHNICAL FIELD AND BACKGROUND OF THE INVENTION

The present invention relates to corrosion in BWR reactors. In particular, the invention relates to a method of reducing electrochemical corrosion potential during the start-up phase of BWR reactors.

The oxidizing chemistry environment of BWR reactor water is a key factor promoting intergranular stress corrosion cracking (IGSCC) of stainless steel and nickel based alloys used to construct reactor coolant system piping and vessel internals. Intergranular stress corrosion cracking (IGSCC) in BWRs is typically mitigated during power operation with hydrogen water chemistry (HWC) or noble metal chemical addition with hydrogen water chemistry (NMCA+HWC).

However, these methods are only completely effective when the reactor is at power. Hydrogen injection is not placed into service until the reactor is at operating temperature and at a power greater than about 5% to 30%, depending on HWC system design. Consequently, the reactor water, which initially contains high dissolved oxygen levels from exposure to atmospheric air during cold shutdown, is oxidizing during heatup and low power operation. As a result, the highest crack growth rates currently occurs during start up, after refueling outages, before HWC becomes effective. Further, electrochemical corrosion potential (ECP) is very high.

Data indicates that IGSCC rates are higher at intermediate temperatures during plant startup and shutdown processes than at operating temperature. As a result, cracking can initiate and crack growth can occur during the plant shutdown process and startup from refueling or mid-cycle outages, when hydrogen injection is not in service. For units with NMCA+HWC, crack growth during the startup and shutdown processes may result in crack flanking, in which existing cracks can continue to grow even after hydrogen injection is on.

Accordingly, a method of reducing electrochemical corrosion potential during the start-up phase of BWR reactors is needed.

### SUMMARY OF THE INVENTION

These and other shortcomings of the prior art are addressed by the present invention, which provides a method of reducing electrochemical corrosion potential during the start-up phase of BWR reactors by injecting amines into the BWR reactors during the start-up phase.

According to one aspect of the present invention, a method of protecting BWR reactors includes the steps of providing a mitigation additive adapted to reduce electrochemical corrosion of a BWR reactor; and injecting the mitigation additive into the BWR reactor at a predetermined location prior to hydrogen injection coming online.

According to another aspect of the present invention, a method of protecting BWR reactors from corrosion during start-up includes the steps of providing a mitigation additive adapted to reduce electrochemical corrosion of a BWR reactor; and injecting the mitigation additive into the BWR reactor during a hydrostatic pressure test.

### BRIEF DESCRIPTION OF THE DRAWINGS

The invention may be best understood by reference to the following description in conjunction with the accompanying drawing figures in which:

FIG. 1 shows ECP vs. Temperature;

FIG. 2 shows ECP vs. Temperature;

FIG. 3 shows RWCU injection points;

FIG. 4 shows additional RWCU injection points;

FIG. 5 is a schematic of an RPV hydrostatic pressure test;

FIG. 6 shows reactor coolant temperature data;

FIG. 7 is a schematic of a BWR startup process;

FIG. 8 is a process flow schematic during startup; and

FIG. 9 shows reactor coolant and condensate dissolved oxygen concentrations.

### DESCRIPTION OF THE PREFERRED EMBODIMENT AND BEST MODE

Under normal water chemistry (NWC), the ECP of primary system materials is typically in the range of 0 to +250 mV (SHE). However, testing has shown that intergranular stress corrosion cracking (IGSCC) of BWR piping is mitigated when the ECP of sensitized stainless steel is lowered to less than −230 mV (SHE) and the reactor coolant conductivity is less than 0.3 μS/cm at 25° C. (77° F.). Currently, IGSCC is mitigated during normal power operating conditions by providing hydrogen injection into the reactor water. This reduces the electrochemical corrosion potential (ECP) of stainless steel and nickel based alloys, thereby mitigating IGSCC.

Hydrogen water chemistry (HWC) is targeted at protecting reactor internals as well as piping. Hydrogen addition suppresses the radiolytic decomposition of water in the core region, which reduces the formation of oxidizing species such as oxygen and hydrogen peroxide. It also provides an excess of dissolved hydrogen in the downcomer region, which promotes the radiolytic recombination of residual oxidants in the recirculating water. In regions where the concentration of oxidants in reactor water is reduced to less than 3 ppb (equivalent O₂) the ECP driving force for IGSCC is eliminated. A drawback to HWC is that it causes main steam line radiation levels to increase by several times the level without hydrogen injection due to N-16 production and carryover with the steam.

Hydrogen injection with Noble Metal Chemical Addition (NMCA+HWC) provides a means of achieving the IGSCC protection of HWC without a large increase in main steam line radiation levels. NMCA involves the deposition of small amounts of noble metal (i.e., platinum, rhodium) on the wetted surfaces in contact with the reactor coolant. These catalyze recombination reactions of hydrogen with oxygen and hydrogen peroxide at those surfaces. The ECP response of the treated surfaces is similar to that of platinum. Protective ECPs are achieved when the molar ratio of hydrogen to total oxidant in reactor water reaches a value equal to or greater than two, which is reached at very low feedwater hydrogen concentrations (usually between 0.1 ppm and 0.3 ppm), about an order of magnitude less than that required by HWC.

A major advantage of NMCA is that there is little or no increase in main steam line radiation from N-16 activity at the low hydrogen addition levels. However, cracking which may initiate or propagate during periods when hydrogen is not available, may not be mitigated when hydrogen is restored. When cracks grow beyond a critical length, oxidants in the bulk water may raise the ECP of the fresh crack surfaces above −230 mV(SHE). This phenomenon is referred to as “crack flanking.”

Temperature effects on materials may also be significant in IGSCC. Based on available data, in relatively high purity/non-transient/below Action Level 1 BWR environments the crack growth rate of BWR structural materials such as Type 304 stainless steel and Alloy 600 reach a maximum at approximately 150° C. to 200° C. (302° F. to 392° F.). It is expected that in lower purity/transient type environments (e.g., >1 μS/cm), the crack growth rates would increase with increasing temperature.

In the present invention, the addition mitigation additives such as amines, including hydrazine and carbohydrazide, are used for lowering the ECP of reactor internals and recirculation piping during the early startup process, from approximately less than 38° C. (100° F.), through the temperature range of 150° C. to 200° C. (302° F. to 392° F.) to the normal operating temperature of approximately 288° C. (550° F.).

Hydrazine reacts with oxygen as follows:

N₂H₄+O₂→N₂+2H₂O

The reaction products, nitrogen and water, do not pose a corrosion concern in the BWR. Carbohydrazide reacts directly with oxygen to produce nitrogen, carbon dioxide and water.

2O₂+(N₂H₃)₂CO→2N₂+3H₂O+CO₂

As with hydrazine, the rate of reaction of carbohydrazide with oxygen increases as temperature increases and at a higher pH. As temperature increases, carbohydrazide decomposition to hydrazine and carbon dioxide becomes significant, so the reaction with oxygen can take place either directly (as shown above) or indirectly with the hydrazine produced.

H₂O+(N₂H₄)₂CO→2N₂H₄+CO₂

2O₂+2N₂H₄→2N₂+4H₂O

Carbohydrazide begins to decompose to hydrazine when temperatures exceed 121° C. (250° F.) and is almost completely decomposed to hydrazine at 176° C. (350° F.).

Hydrazine treatment may be used to scavenge dissolved oxygen while the plant is in heatup from 65° C. to 121° C. (150° F. to 250° F.). Hydrazine treatment is most effective when dissolved oxygen has been reduced to a few ppm by mechanical methods. Hydrazine should be added early in the heat-up process as the temperature reaches 65° C. (150° F.) to allow time for the reaction to proceed at the reduced rate at lower temperature. The reaction kinetics improve substantially as the temperature is increased to 93° C. to 121° C. (200° F. to 250° F.).

Loop test results show that hydrazine injection decreases the measured ECP of an NMCA treated specimen to a significantly greater extent than that of an untreated filmed specimen over the temperature range of 93° C. to 204° C. (200° F. to 400° F.). This indicates that the NMCA treatment enhances the catalytic effect of the oxygen/hydrazine reaction at the surface. The results also show that the ECP decreases as the hydrazine to oxygen concentration ratio is increased and as the temperature increases. With the NMCA treated specimen, significant ECP reduction is achieved with excess hydrazine over oxygen at 93° C. to 149° C. (200° F. to 300° F.) compared with the measured ECP at less than 2 ppb oxygen without hydrazine injection, while at 204° C. (400° F.) the ECP with hydrazine injection over the range tested is similar to that with less than 2 ppb oxygen. The ECP reduction of the prefilmed untreated specimen with hydrazine injection at 93° C. and 149° C. (200° F. and 300° F.) compared with the ECP at less than 2 ppb oxygen is significantly smaller than that for the NMCA treated specimen, even at high hydrazine to oxygen ratios.

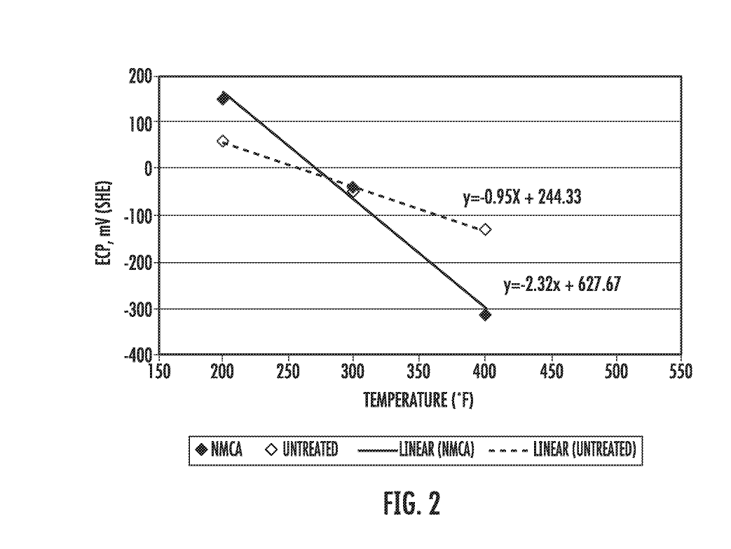

With an ECP(SHE) that approaches that at low temperature at an oxygen concentration of less than or equal to 2 ppb, the test results showed that mitigation can be achieved by hydrazine injection if a hydrazine to oxygen ratio of greater than 5 to 10 is established. The measured ECP values at an oxygen concentration of less than or equal to 2 ppb from the loop tests discussed above are shown in FIG. 2. Extrapolation of these results to 260° C. (500° F.) shows ECP values of −231 mV (SHE) for the untreated specimen and −532 mV (SHE) for the NMCA specimen.

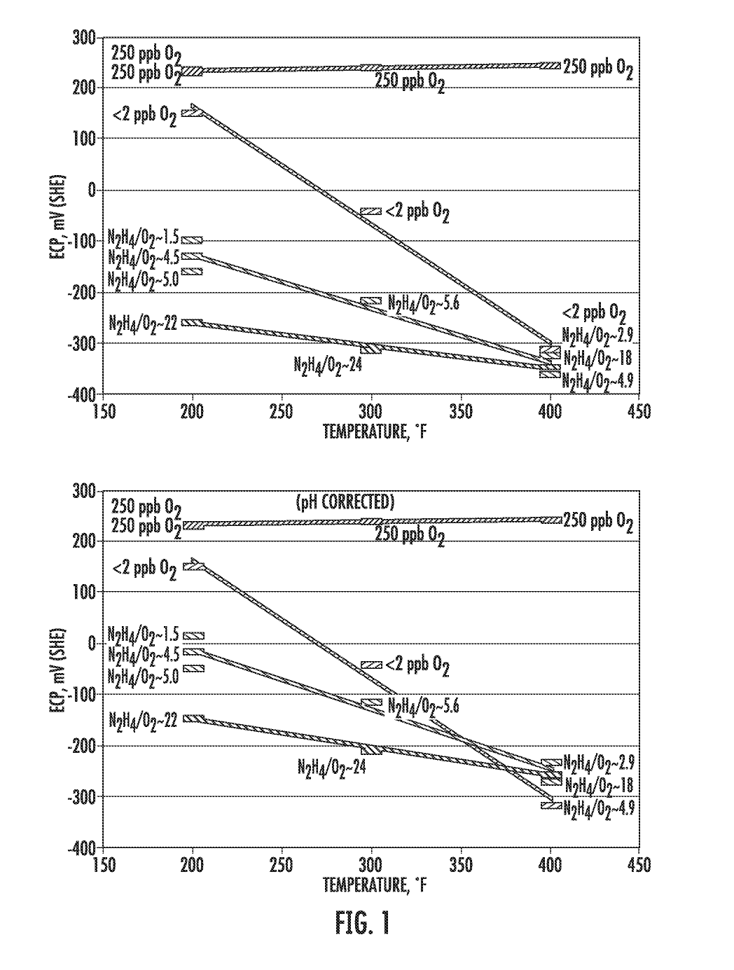

The muted response of the untreated prefilmed specimen was unexpected, since laboratory and operating experience indicates that corrosion potentials at or below −500 mV(SHE) at operating temperature can be achieved in the absence of noble metal coatings if oxygen is reduced to less than 5 ppb. In conjunction with the 250 ppb O₂ data from FIG. 1, the curve for the NMCA treated specimen can be used to establish the ECP suppression that is associated with IGSCC mitigation at the various temperatures. For example, at 93° C. (200° F.) the ECP must be reduced by greater than 80 mV, at 149° C. (300° F.) by greater than 290 mV, and at 204° C. (400° F.) by ˜500 mV.

During a typical plant startup evolution from shutdown to full power, there is a significant time period when the reactor coolant temperature is greater than 93° C. (200° F.) and IGSCC is not mitigated, since hydrogen injection is not started until power is between 30% and 50%. This period of time is due to reactor vessel reassembly and pressure leak testing. While reactor coolant temperatures are maintained less than 49° C. (120° F.) during refueling conditions, temperatures are increased to above 100° C. (212° F.) during the vessel pressure leak test (hydrostatic pressure test). Coolant temperatures are initially increased above normal shutdown temperatures to support setting and tensioning the reactor head. Once the head has been tensioned, a plant can prepare for the pressure leak test.

Plant procedures provide limits for heat-up and cool-down rates during the pressure leak test. The time above 100° C. (212° F.) during the test is plant specific and may vary depending on the scope of the test. For example, it could range from as little as 4 to 8 hours to as much as 12 to 24 hours. After the leak test is complete, the coolant temperature is lowered to less than 93° C. (200° F.) using shutdown cooling. The temperature is maintained typically between 54° C. and 65° C. (130° F. and 150° F.) as a station completes final reactor reassembly. One to two shifts (12-24 hours) after successful leak testing is typically required to complete the final reactor reassembly.

In preparation for startup, the control rod drive (CRD), reactor water cleanup (RWCU) and Condensate systems are in service and the long path feedwater flush is completed. The reactor head vent is open. The condensate system is initially operating on short path recirculation with one or more demineralizers in service.

Upon startup, shutdown cooling is secured and reactor recirculation pumps are started. The reactor is brought to critical condition by initial control rod withdrawal and heat-up above 93° C. (200° F.) commences. Initially, the reactor head vent may be opened until a few pounds pressure is established in the reactor vessel. The main steam line drains are opened as well to direct any condensed liquid to the main condenser. Condenser vacuum is initially established with mechanical vacuum pumps and later on with a steam jet air ejector system when reactor pressure increases to between 200 psig and 300 psig and sufficient steam flow is available.

At 100 psig reactor pressure, the steam jet air ejector (SJAE) and offgas preheater are switched to main steam. RWCU blowdown to the hotwell is secured when reactor pressure vessel (RPV) level can no longer be maintained by CRD flow. The first turbine bypass valve is about 10%-20% open at about 150 psig reactor pressure.

Main steam flow is routed to the main condenser through the turbine bypass valves. As condensate/feedwater flow increases, additional pumps are brought into service as required. The reactor is placed in the Run mode when reactor pressure increases to approximately 1000 psig, after which the main turbine is rolled and the generator is synchronized to the grid. Power ascension then continues at a rate within plant technical specification limits until 100% power is established.

The reactor pressure vessel leak test is important because temperatures during the test are increased to greater than 93° C. (200° F.) and the time spent above 93° C. (200° F.) is counted as time when IGSCC is not mitigated.

Control rod withdrawal continues until the coolant temperature is 100° C. (212° F.), at which point the main steam isolation valves (MSIVs) can be opened. The requirement for opening the MSIVs is that the RPV pressure must be positive. Rod withdrawal continues while maintaining the heatup rate at less than 100° F./hr. A reactor coolant dissolved oxygen hold point is established prior to exceeding 50 psig (˜296° F.).

The time of initial control rod withdrawal to the time reactor coolant temperature reaches 93° C. (200° F.) is normally about four hours. Hydrazine injection would need to commence shortly after shutdown cooling is secured and the second reactor recirculation pump is started to ensure that availability would not be lost when the temperature first reaches 93° C. (200° F.). Hydrogen injection can not be started until the second reactor feedwater pump is in service. This occurs at about 33% power, after the main generator is synchronized to the grid. The time between when the coolant temperature first reaches 93° C. (200° F.) to the time the second feed pump is placed in service can very significantly, depending upon problems encountered and the number of surveillance tests, such as reactor core isolation cooling (RCIC) and high pressure injection cooling (HPCI) operability tests, required during the specific startup. During testing, reactor pressure is maintained constant. The coolant temperature during this period is in an intermediate range where higher crack growth rates may occur.

It is conceivable that during the reactor coolant temperature could exceed 93° C. (200° F.) for 72 hours or more prior to starting the normal hydrogen injection system during a plant startup from a refueling outage.

Hydrazine or carbohydrazide is injected into a flowing plant water stream as a liquid solution. It would be preferable if the same injection system could be used in all phases of startup where chemical injection will be performed.

A chemical injection skid would be used and includes solution tanks, metering pumps, valves, tubing, instrumentation and controls. Chemicals are metered from the chemical injection skid to a drive water skid which also includes pumps, flow instrumentation and controls, and provides dilution water for chemical introduction into the plant process line.

To minimize complications it is preferred to limit the number of selected injection locations. A single location would avoid the need to consider logistics of transporting the chemical to multiple locations in sufficient quantities and the possible need for more than one injection system. Moving chemicals from one location to another may increase risk of a spill, which could impact personnel access to the plant, HVAC, and drains.

Three injection locations will be discussed herein. The first is injection into the RWCU Effluent system. Flow is normally circulating through the RWCU system during reactor vessel pressure leak testing (with the cleanup demineralization vessels bypassed) and during the entire heatup and startup process. The RWCU system inlet is from a reactor recirculation loop and the vessel bottom drain, and most plants draw the normal reactor water sample that is routed to the reactor sample panel from this stream. The RWCU return flow at most plants is to the feedwater system downstream of all feedwater heaters and just upstream of the reactor vessel connection. The RWCU return flow path is through the shell side of the regenerative heat exchanger. Potential injection tie-in locations may be upstream or downstream of the regenerative heat exchanger, although downstream would be preferred to minimize the contact surface area for hydrazine reactions prior to entry into the reactor vessel. If RWCU materials of construction are largely carbon steel, the injection point should be as close as possible to the point where the RWCU return connects with the feedwater system to address flow accelerated corrosion issues.

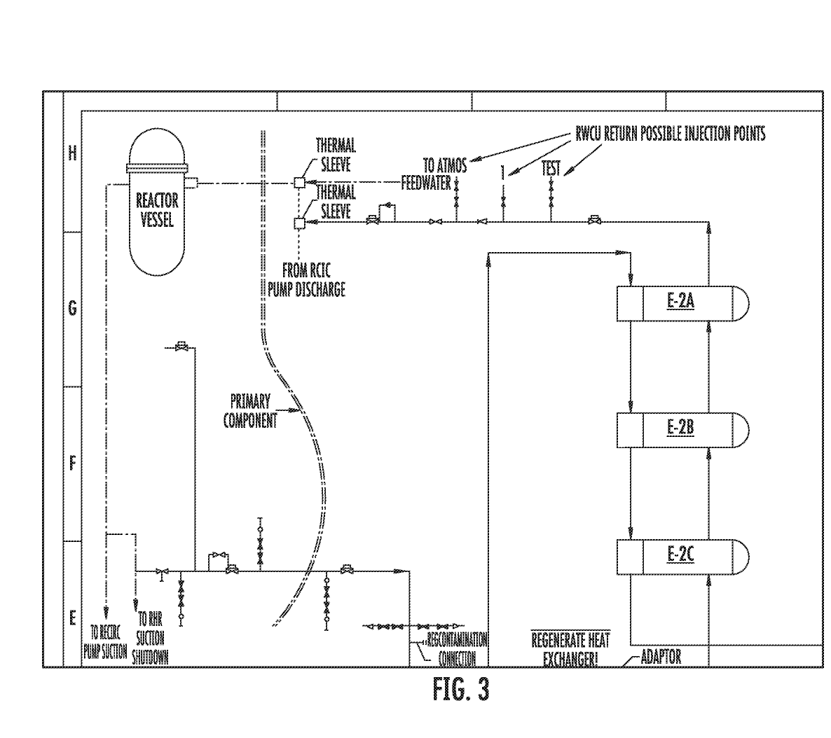

An example of possible tie-in locations for chemical injection to the RWCU system at a BWR-4 design is shown in FIG. 3. FIG. 3 is a typical RWCU system configuration where piping is provided with a number of connection taps to ensure that the system can be properly vented for startup and drained for maintenance.

During the vessel hydrostatic test and during the initial heat-up, there is essentially no feedwater flow. The feedwater piping at the tie-in point may or may not be full, depending upon the boundary for the hydrostatic test, which may be outage and plant specific. With only RWCU return flow, the velocity in the feedwater piping will be low, which increases residence and contact time with the carbon steel feedwater pipe surface for hydrazine decomposition.

A second injection location where hydrazine may be added directly to the reactor water recirculation system is in the reactor recirculation system. This approach is similar to an injection approach used for the classic noble metal applications. The taps typically used for classic noble metal injection into the reactor water recirculation system are either the recirculation pump differential pressure instrument taps or the recirculation pump flow instrument taps. These taps, which can be accessed outside of primary containment, are small in diameter and typically contain excess flow check valves to prevent gross leakage of reactor coolant outside of primary containment.

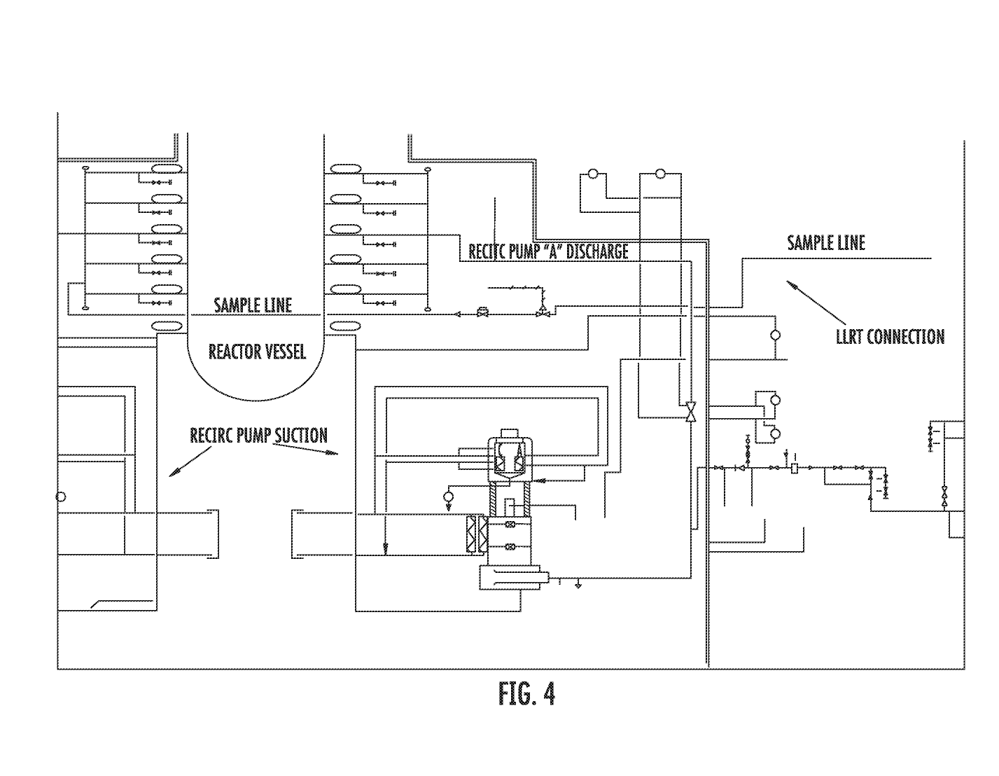

Another possible injection location is into the reactor water recirculation loop, such as into the root connection of the recirculation system sample point. This is shown in FIG. 4. At most BWRs, this sample point is from the discharge piping of one of the reactor water recirculation pumps (for the example shown in FIG. 4, the sample point connection is in the “B” reactor recirculation pump discharge). The sample system usually contains inboard and outboard containment isolation valves. The piping typically contains drain connections that are used for performing local leak rate testing (LLRT) of the containment isolation valves during refueling outages. One set of LLRT drain connections is typically located outside containment, just upstream of the outboard isolation valve. Conceivably, the outboard containment isolation valve would be closed, the inboard valve open, and hydrazine could be injected into the LLRT drain connection between the containment isolation valves. Unlike injecting into the recirculation pump differential pressure or flow instrument line, hydraulic sensing instrumentation is not affected. At most plants, the primary reactor coolant sample point is in the inlet to the RWCU system, and this sample would not be impacted by using the reactor recirculation system sample point. However, the reactor recirculation system sample point used for injection would not be available as an alternate or backup sample point when the chemical is being injected. The reactor recirculation system sample line would have to be adequately rinsed prior to use after chemical injection.

If a LLRT connection is not available outside of containment, upstream of the outboard isolation valve, it may be possible to connect the chemical injection line to the reactor recirculation sample line downstream of the outboard containment isolation valve. This could be either through another drain line connection or just prior to the sample line tie-in at the chemistry sample station. The recirculation system injection points offer the advantage over the RWCU system injection point that they are not dependent upon RWCU pump operability.

For the plant configuration shown in FIG. 4, the “B” recirculation system sample tap also supplies flow to the Durability Monitor. However, at most plants the normal reactor coolant sample flow and flow to the Durability Monitor is taken from the RWCU system inlet, so injecting into the recirculation system as discussed above is feasible.

If mitigation of IGSCC is desired in the recirculation loop and in the downcomer, both loops should be in operation with hydrazine injected to both loops. If chemical injection into both recirculation loops (two-loop plants) is required to assure effectiveness, an instrument tap would probably have to be used for one loop while the sample/LLRT connection could be used for the other loop. The actual selection of injection points would be site specific.

Hydrazine injection to the feedwater through the RWCU return lines has the advantage of avoiding the core flow region and delivering hydrazine to the top of the downcomer, which is beneficial to assuring that the hydrazine to oxidant ratio is high enough to mitigate IGSCC of the shroud O.D. and downcomer components such as the jet pump beams and recirculation riser welds. This may be a good injection point during floodup for the hydrotest, if condensate is used for flooding. However, during RWCU operation without condensate flow, the flow rate through the feedwater lines will be slow (˜1% of full power with a 1% RWCU system) and the volume may be large, depending on plant geometry. There may be significant losses of hydrazine by surface catalyzed reactions with the carbon steel piping. With this injection mode both recirculation loops should be in operation to provide uniform distribution of hydrazine throughout the vessel and recirculation system.

For plants that flood up for the hydrotest from core spray, it may be possible to inject a chemical into the core spray system if an accessible connection is available. The low pressure core spray system typically includes test connections at the pump suction which could be used for injection.

The third injection location is in the CRD system. The CRD system is in service from cold shutdown through power operation and therefore offers a convenient potential chemical injection location. During the plant heatup and startup period of interest, the CRD suction is fed from the condensate demineralizer effluent, so injection into the CRD suction would be at condensate demineralizer system effluent temperature pressure. The injection point would be at a drain connection associated with the CRD pump piping.

There are three phases where injection would occur. In phase 1, hydrazine injection would occur during the reactor hydrostatic pressure leak test and the initial heat-up during startup when there is only minor venting from the reactor vessel. In phase 2, hydrogen injection would occur when the reactor power is very low (<1%) and there is only minor steam flow. In phase 3, hydrogen injection would occur when power is increased up to 5%, and steam flow becomes significant.

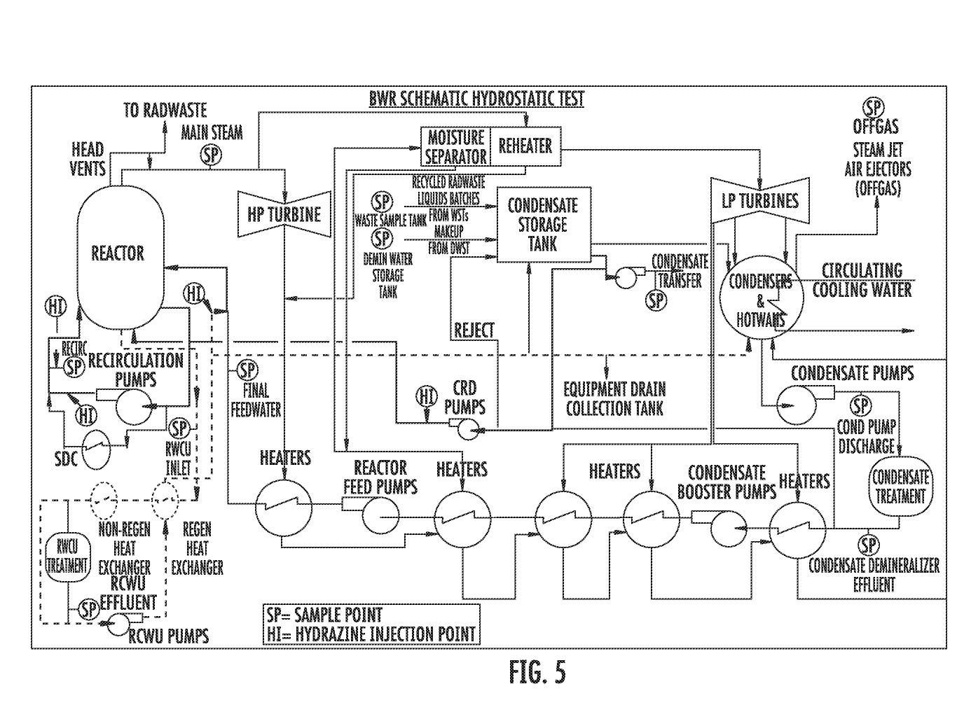

The RPV hydrostatic pressure test represents the initial phase (Phase 1) of preparation for startup where the reactor coolant temperature is heated above 93° C. (200° F.). A simplified process schematic of key plant systems during the RPV hydrostatic pressure test is shown in FIG. 5. The schematic shows the RWCU system operating with the RWCU water purification equipment bypassed. CRD supplies condensate water to the vessel and there is a letdown flow path from RWCU that is normally routed to the main condenser. The flow path shown in FIG. 5 shows the CRD suction lined up to the condensate storage tank (CST), but the CRD suction flow may be provided from the condensate demineralizer system effluent if a condensate pump is operating and the condensate demineralizer system is available. Temperature is raised to above 93° C. (200° F.) using reactor recirculation pump heat. The possible hydrazine injection points discussed previously are shown in FIG. 5.

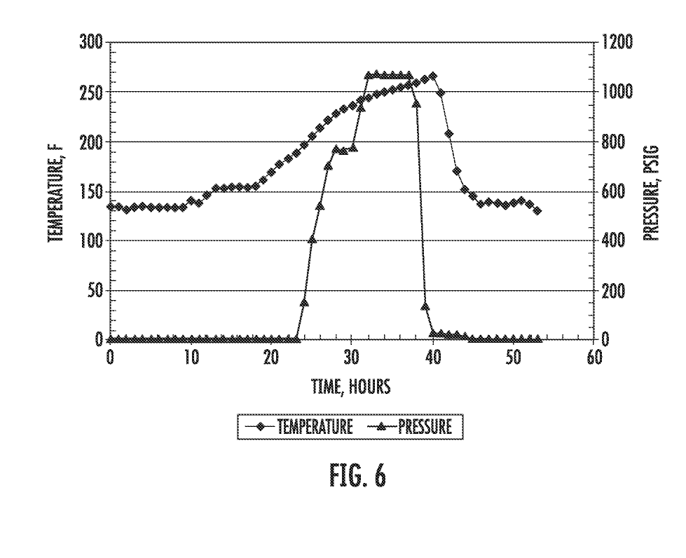

Example reactor coolant temperature data prior to, during, and following an RPV hydrostatic pressure test at a BWR-4 is shown in FIG. 6. For this evolution, the reactor coolant temperature peaked at about 129° C. (265° F.) and was above 93° C. (200° F.) for a total period of about 18 hours. The time duration of 18 hours above 93° C. (200° F.) in this example could be longer if the test had to be repeated due to unacceptable leakage.

In the example shown in FIG. 6, the coolant temperature was increased in steps, from an initial level of about 56° C. (133° F.) to approximately 67° C. (153° F.), where the temperature remained constant for about five hours prior to the start of the heat-up. It took approximately six hours to increase the temperature from 67° C. (153° F.) to greater than 93° C. (200° F.). Increasing reactor pressure was first indicated when temperature reached about 88° C. (190° F.), and the peak pressure of about 1067 psig was reached in approximately 9 hours. The peak pressure was held for a period of about five hours. Pressure was then reduced to about 28 psig. After completion of the pressure test, the temperature decreased from the peak value of 129° C. (265° F.) to greater than 93° C. (200° F.) in about 3 hours.

To ensure sufficient hydrazine is present at the time the coolant temperature is greater than 93° C. (200° F.), injection would need to start earlier. Thus, it would be advantageous to start hydrazine addition during the initial vessel fill prior to the start of the hydrostatic test. The time it takes to fill the vessel depends on plant-specific procedures. If at the start of the fill, the water level is at the normal operating level, a large mass of water would have to be added to reach the level needed for the hydrostatic pressure test.

In addition, hydrazine could also be injected during the six hour period of coolant temperature increase from 65° C. to 93° C. (150° F. to 200° F.). During this period, oxygen is transported into the reactor vessel with the CRD flow and production of hydrogen peroxide from the core gamma flux would continue. Letdown flow from RWCU also occurs at this time.

Additional hydrazine may have to be added after the temperature reaches greater than 93° C. (200° F.). Water added via CRD during the hydrostatic pressure test may approach air saturation levels as most plants do not have condenser vacuum established at that time. ECP data, if available, could be used to determine if additional hydrazine is required.

During the hydrostatic pressure test, injection through the recirculation system sample line or a recirculation pump differential pressure or flow tap would be preferred over injection into RWCU. Since there is no feedwater flow, the velocity in the large feedwater pipe from the RWCU flow would be very low. Injection into the recirculation system would provide better mixing within the piping and in the reactor vessel.

During the hydrostatic test, the oxygen source in the water is from air saturation and not from radiolysis. At least an equivalent quantity of hydrazine would be required to consume the oxygen inventory assuming no other source terms. Since the rate of hydrazine reaction with oxygen is indicated to be slow at low temperature (˜49° C. or 120° F.) prior to heat-up, it may be prudent to delay hydrazine injection until reactor water temperature is higher, approaching 93° C. (200° F.), where the reaction proceeds more rapidly. Residual hydrazine and its decomposition products would be removed with the letdown flow.

Oxygen should be removed from the reactor water by mechanical means, to the extent practical, to minimize the amount of hydrazine required. The available mechanical means would be to establish condenser vacuum with the mechanical vacuum pumps, and open main steam line drains to allow vacuum to be drawn on the reactor vessel (head vent would also have to be open).

Following the hydrostatic pressure test, the next opportunity for hydrazine injection is during the initial heatup and early startup. If hydrazine were added during the hydrostatic test, dissolved oxygen levels in the coolant would increase after the hydrostatic test is complete because of continuous input from CRD. Typically, startup commences within 24 hours after the hydrostatic test is completed. This time period could be longer due to emergent work or issues, which could further increase the dissolved oxygen content at startup.

In the early startup phase, oxygen input to the reactor coolant is from the condensate/feedwater, and small contribution from radiolysis in establishing reactor criticality. Initially, water entering the reactor vessel from condensate/feedwater system is high due to oxygen dissolution from air, but the oxygen content declines following the establishment of condenser vacuum. During heatup, when initial condenser vacuum is established using the mechanical vacuum pump, reactor coolant dissolved oxygen is typically approximately 250 ppb. Dissolved oxygen levels in the coolant will begin to decline as temperature increases due to decreased solubility. It usually requires operation of the steam jet air ejector system to lower the oxygen content of the condensate water to less than 100 ppb. The establishment of condenser vacuum with open MSIVs and main steam line drains draws oxygen released from the heat-up from the reactor vessel.

Prior to initial control rod movement, plant procedure requires starting the reactor recirculation system and securing shutdown cooling. This would be the appropriate time to initiate hydrazine injection as the recirculation pump start will provide mixing in the reactor vessel.

In phase 2, once heat-up begins, it does not take long (between 6 to 10 hours) for the reactor temperature to reach about 177° C. (350° F.). The corresponding reactor pressure at this temperature is about 134 psig. At this point, significant steam venting occurs. There is sufficient steam flow to open a turbine bypass valve, to perform operability tests with the HPCI and RCIC turbine driven pumps (the design at most plants), and at some stations, to place the steam jet air ejectors in service. As the temperature increases to above 260° C. (500° F.) oxygen content continues to decline, indicating that the input from radiolysis is low. As power ascension continues, the dissolved oxygen source is mainly from radiolysis.

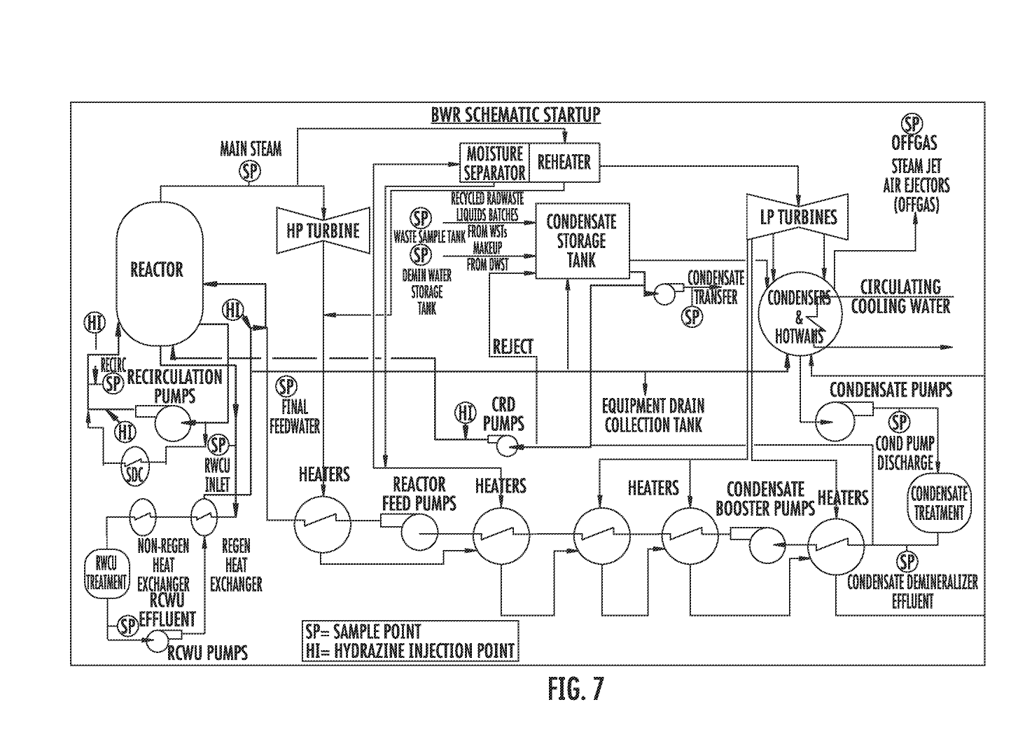

A simplified schematic flow diagram during a startup process is shown in FIG. 7. Potential injection points previously discussed are also shown. Injection into the recirculation system during heat-up is viable. For the RWCU injection point, initially plants may be in the letdown lineup for reactor level control. As steam flow increases, letdown is secured.

The injection approach is to start hydrazine injection upon starting the first reactor recirculation pump and securing shutdown cooling. Sufficient hydrazine should be added to build up an inventory so that mitigation can be achieved when the coolant temperature reaches 93° C. (200° F.). If ECP data is not available during the early startup, it may be possible to assess effectiveness of hydrazine using reactor coolant sample dissolved gas (oxygen and hydrogen) measurements. These measurements could also be used as the basis for changes to the hydrazine injection rate.

As discussed above, when reactor coolant temperature increases to about 177° C. (350° F.), sufficient steam flow is available to require opening of the first turbine bypass valve and to perform operability testing of emergency system steam driven pumps (Phase 3). Plants with an auxiliary steam source may have the SJAE system in service at this temperature. If not, placing the SJAE system in service is typically one of the first activities performed as pressure is increased beyond 150 psig.

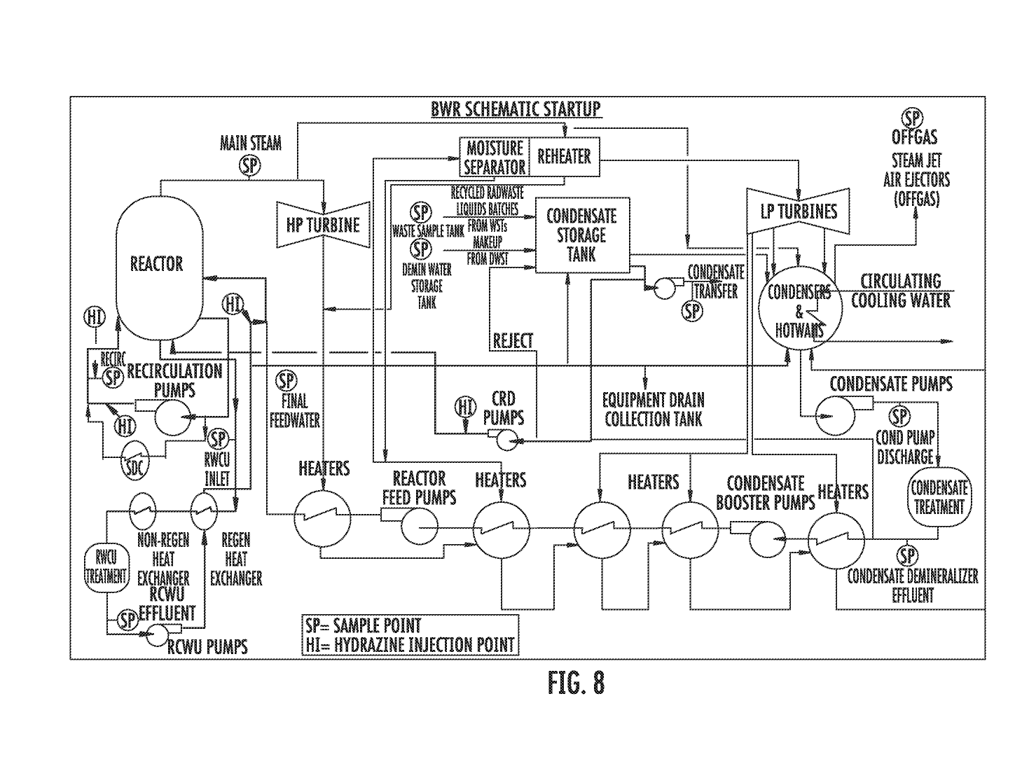

A process flow schematic during startup is shown in FIG. 8, which shows steam flow to the condenser from the turbine bypass. At this point, there is some flow through the condensate/feedwater system, but there is no steam flow to the feedwater heaters so feedwater temperature is cool compared to normal plant operating conditions.

If a plant is designed with condensate booster pumps, the first booster pump is typically placed in service when reactor pressure is between 150 psig and 200 psig. The first reactor feedwater pump is normally placed in service when reactor pressure is between 400 psig and 500 psig. Once the first feedwater pump is placed in service, further control rod movement is accomplished to bring the reactor temperature to greater than 260° C. (500° F.) and the reactor pressure to between 950 psig-1000 psig. Typical BWR-4 startup data shows that the time duration to increase reactor temperature from 177° C. (350° F.) to about 271° C. (520° F.) is approximately 12 hours (average temperature increase rate approximately 14° F. per hour).

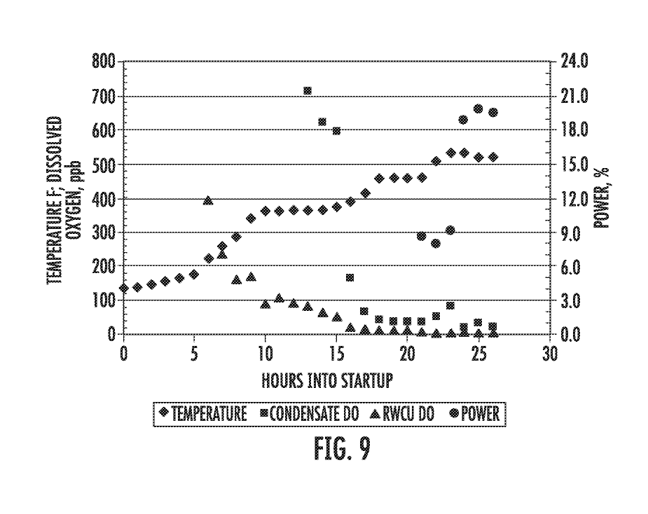

Example reactor coolant and condensate dissolved oxygen concentrations for a BWR-4 with NMCA during startup and power ascension, prior to the start of hydrogen injection, are plotted in FIG. 9. Reactor coolant temperature and reactor power trends are also shown. The effect of the establishing condenser vacuum on oxygen levels is clearly shown. The rapid decline in condensate oxygen from greater than 700 ppb to well below 100 ppb corresponds with starting SJAE operation. Generally, plants are required to secure the mechanical vacuum pumps prior to exceeding 5% power because of concerns related to explosive gas mixtures and radiological releases. Reactor coolant dissolved oxygen declined from about 400 ppb at a temperature of 106° C. (223° F.) to about 100 ppb at a temperature of about 184° C. (363° F.). When condensate oxygen decreased to less than 100 ppb, coolant dissolved oxygen was at about 16 ppb.

The plant power data points in FIG. 9 shows that when the coolant temperature first increased above 260° C. (500° F.), power was between 8 and 9%.

Hydrazine demand to lower ECP from the point of significant steam flow (reactor pressure at approximately 150 psig) through 5% power is relatively low, based on the dissolved oxygen trend shown in FIG. 9, which is prior to the start of hydrogen injection. There is no issue with injecting into RWCU during this period since letdown from RWCU is secured during this phase and the residence time in the feedwater piping would be lower due to increasing feedwater flow. Injection into the recirculation system sample line would also be acceptable. Monitoring for effectiveness could be achieved using RWCU dissolved gas measurements and ECP, if available.

After reaching 5% power, a plant will focus on increasing reactor pressure and temperature to provide enough steam to begin warming the main turbine in preparation for roll and synchronization to the grid. Plants typically synchronize to the grid at about 20% power. Reactor coolant dissolved oxygen levels will increase due to oxidants from radiolysis reactions and possibly from increases in oxygen input from the condensate/feedwater system due to increases in air inleakage as subsystems and components in direct communication with the condenser are first placed in service.

A method of protecting BWR reactors from corrosion during start-up is described above. Various details of the invention may be changed without departing from its scope. Furthermore, the foregoing description of the preferred embodiments of the invention and best mode for practicing the invention are provided for the purpose of illustration only and not for the purpose of limitation.

We claim:

1. A method of protecting BWR reactors, comprising the steps of:
(a) providing a mitigation additive adapted to reduce electrochemical corrosion of a BWR reactor; and
(b) injecting the mitigation additive into the BWR reactor at a predetermined location prior to hydrogen injection coming online.

2. The method according to claim 1, wherein the mitigation additive is an amine.

3. The method according to claim 1, wherein the mitigation additive is hydrazine.

4. The method according to claim 1, wherein the mitigation additive is carbohydrazide.

5. The method according to claim 1, wherein the mitigation additive is used to scavenge dissolved oxygen during plant heat-up from sixty-five degrees Celsius to one hundred and twenty-one degrees Celsius.

6. The method according to claim 1, wherein the mitigation additive is injected into a flowing plant water stream as a liquid solution.

7. The method according to claim 1, wherein the mitigation additive is injected into a reactor water cleanup system of the BWR reactor.

8. The method according to claim 1, wherein the mitigation additive is injected into a reactor recirculation system of the BWR reactor.

9. The method according to claim 8, wherein the mitigation additive is injected into a recirculation pump differential pressure instrument tap of the reactor recirculation system.

10. The method according to claim 8, wherein the mitigation additive is injected into a reactor water recirculation loop of the reactor recirculation system.

11. The method according to claim 1, wherein the mitigation additive is injected into a control rod drive system of the BWR reactor.

12. The method according to claim 1, wherein the mitigation additive is injected during a reactor hydrostatic pressure leak test.

13. The method according to claim 1, wherein the mitigation additive is injected when reactor power is less than 1%.

14. The method according to claim 1, wherein the mitigation additive is injected as reactor power is increased up to 5%.

15. A method of protecting BWR reactors from corrosion during start-up, comprising the steps of:
(a) providing a mitigation additive adapted to reduce electrochemical corrosion of a BWR reactor; and
(b) injecting the mitigation additive into the BWR reactor during a hydrostatic pressure test.

16. The method according to claim 15, wherein the mitigation additive is injected into the BWR reactor during the hydrostatic pressure test at a location selected from the group consisting of a recirculation system sample line and a recirculation pump differential pressure tap.

17. The method according to claim 15, further including the step of injecting the mitigation additive into the BWR reactor during initial heat-up.

18. The method according to claim 15, further including the step of injecting the mitigation additive into the BWR reactor during initial vessel fill prior to the hydrostatic test.

19. The method according to claim 15, further including the step of injecting the mitigation additive into the BWR reactor upon starting of a first reactor recirculation pump.

20. The method according to claim 15, wherein the mitigation additive is an amine selected from the group consisting of hydrazine and carbohydrazide.
